(19) United States
(12) Patent Application Publication
(10) Pub. No.: US 2017/0269732 A1
(43) Pub. Date: Sep. 21, 2017

(54) TOUCH-SENSING DISPLAY PANEL

(71) Applicant: Industrial Technology Research Institute, Hsinchu (TW)

(72) Inventors: Chih-Chia Chang, Hsinchu County (TW); Kai-Ming Chang, New Taipei City (TW); Yi-Shou Tsai, Taipei City (TW)

(73) Assignee: Industrial Technology Research Institute, Hsinchu (TW)

(21) Appl. No.: 15/359,596

(22) Filed: Nov. 22, 2016

Related U.S. Application Data
(60) Provisional application No. 62/309,971, filed on Mar. 18, 2016.

(30) Foreign Application Priority Data
Aug. 23, 2016 (TW) 105126954

(51) Int. Cl. G06F 3/044

(52) U.S. Cl. CPC G06F 3/044; G06F 2203/04103; G06F 2203/04111

(57) ABSTRACT

A touch-sensing display panel including a display panel and a touch-sensing panel deposed on the display panel is provided. The display panel includes a reflective layer. The touch-sensing display includes a touch-sensing surface. The touch-sensing display includes a filter layer, a gray film, and a touch-sensing device layer. The light transmitted from the touch-sensing surface toward the display panel and the touch-sensing panel is reflected by the reflective layer. The optical density ratio between the filter layer and the gray film with respect to visible light is N, wherein N is between 1 and 40.

### CROSS-REFERENCE TO RELATED APPLICATION

This application claims the priority benefits of U.S. provisional application Ser. No. 62/309,971, filed on Mar. 18, 2016 and Taiwan application serial no. 105126954, filed on Aug. 23, 2016. The entirety of each of the above-mentioned patent application is hereby incorporated by reference herein and made a part of this specification.

### TECHNICAL FIELD

The disclosure relates to a display panel, and particularly relates to a touch-sensing display panel.

### BACKGROUND

A touch-sensing display panel includes a display panel and a touch-sensing panel. The touch-sensing panel may be built in the display panel or attached onto the display panel. Based on different sensing types, touch-sensing panels may be generally categorized into resistive touch-sensing panels, capacitive touch-sensing panels, optical touch-sensing panels, acoustic-wave touch-sensing panels and electromagnetic touch-sensing panels. The capacitive touch-sensing panels may characterize as having a short response speed, favorable reliability, satisfactory durability, and so on. Therefore, the capacitive touch-sensing panels are widely used in electronic products.

Generally speaking, due to the reflective optical property of an electrode or a medium, ambient light may result in reflection on the appearance of a touch-sensing display panel. Thus, the color quality of light beams with colors displayed on the touch-sensing display panel may be affected. Currently, options for facilitating the color quality of the light beams with colors displayed on the touch-sensing display panel include canceling the reflection of ambient light by attaching a polarizing film or a retardation film on a touch-sensing surface of the touch-sensing display panel.

### SUMMARY

A touch-sensing display panel according to an embodiment of the disclosure includes a display panel and a touch-sensing panel disposed on the display panel. The display panel has a reflective layer. The touch-sensing panel has a touch-sensing surface. The touch-sensing panel includes at least one filter layer, a gray film, and a touch-sensing device layer. Light transmitted from the touch-sensing surface toward the touch-sensing panel and the display panel is reflected by the reflective layer. An optical density ratio between the filter layer and the gray film with respect to visible light is N, and N is between 1 and 40.

A touch-sensing display panel according to an embodiment of the disclosure includes a display panel and a touch-sensing panel disposed on the display panel. The display panel has a reflective layer. The touch-sensing panel has a touch-sensing surface. The touch-sensing panel includes a gray film, and a touch-sensing device layer. The touch-sensing device layer includes a plurality of filter touch-sensing conductive layers electrically insulated from one another. Light transmitted from the touch-sensing surface toward the touch-sensing panel and the display panel is reflected by the reflective layer. An optical density ratio between the filter touch-sensing conductive layers and the gray film with respect to visible light is N, and N is between 1 and 40.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic cross-sectional view illustrating a touch-sensing display panel according to a first embodiment of the disclosure.

FIG. 1B is a partially enlarged schematic view illustrating a light emitting region EM of FIG. 1A.

FIG. 1C is a schematic bottom view illustrating the touch-sensing display panel according to the first embodiment of the disclosure.

FIG. 2A is a schematic cross-sectional view illustrating a touch-sensing display panel according to a second embodiment of the disclosure.

FIG. 2B is a schematic cross-sectional view illustrating a touch-sensing display panel according to an embodiment of the disclosure.

FIG. 2C is a schematic cross-sectional view illustrating a touch-sensing display panel according to another embodiment of the disclosure.

FIG. 3 is a schematic cross-sectional view illustrating a touch-sensing display panel according to a third embodiment of the disclosure.

FIG. 4 is a schematic cross-sectional view illustrating a touch-sensing display panel according to a fourth embodiment of the disclosure.

FIG. 5 is a schematic cross-sectional view illustrating a touch-sensing display panel according to a fifth embodiment of the disclosure.

FIG. 6A is a schematic bottom view illustrating a touch-sensing display panel according to a sixth embodiment of the disclosure.

FIG. 6B is a schematic cross-sectional view illustrating the touch-sensing display panel according to the sixth embodiment of the disclosure.

FIG. 7 is a schematic cross-sectional view illustrating a touch-sensing display panel according to a seventh embodiment of the disclosure.

FIG. 8 is a schematic cross-sectional view illustrating a touch-sensing display panel according to an eighth embodiment of the disclosure.

FIG. 9 is a schematic cross-sectional view illustrating a touch-sensing display panel according to a ninth embodiment of the disclosure.

FIG. 10 is a schematic cross-sectional view illustrating a touch-sensing display panel according to a tenth embodiment of the disclosure.

FIG. 11 is a schematic cross-sectional view illustrating a touch-sensing display panel according to an eleventh embodiment of the disclosure.

FIG. 12 is a schematic cross-sectional view illustrating a touch-sensing display panel according to a twelfth embodiment of the disclosure.

FIG. 13 is a schematic cross-sectional view illustrating a touch-sensing display panel according to a thirteenth embodiment of the disclosure.

FIG. 14 is a schematic cross-sectional view illustrating a touch-sensing display panel according to a fourteenth embodiment of the disclosure.

FIG. 15 is a schematic cross-sectional view illustrating a touch-sensing display panel according to a fifteenth embodiment of the disclosure.

FIG. 16 is a schematic cross-sectional view illustrating a touch-sensing display panel according to a sixteenth embodiment of the disclosure.

FIG. 17 is a schematic cross-sectional view illustrating a touch-sensing display panel according to a seventeenth embodiment of the disclosure.

FIG. 18 is a schematic cross-sectional view illustrating a touch-sensing display panel according to an eighteenth embodiment of the disclosure.

FIG. 19 is a schematic cross-sectional view illustrating a touch-sensing display panel according to a nineteenth embodiment of the disclosure.

FIG. 20 is a schematic cross-sectional view illustrating a touch-sensing display panel according to a twentieth embodiment of the disclosure.

FIG. 21 is a schematic cross-sectional view illustrating a touch-sensing display panel according to a twenty-first embodiment of the disclosure.

FIG. 22 is a schematic bottom view illustrating a touch-sensing display panel according to a twenty-second embodiment of the disclosure.

FIG. 23 is a schematic bottom view illustrating a touch-sensing display panel according to a twenty-third embodiment of the disclosure.

FIG. 24 is a schematic bottom view illustrating a touch-sensing display panel according to a twenty-fourth embodiment of the disclosure.

FIG. 25 is a schematic bottom view illustrating a touch-sensing display panel according to a twenty-fifth embodiment of the disclosure.

### DETAILED DESCRIPTION OF DISCLOSED EMBODIMENTS

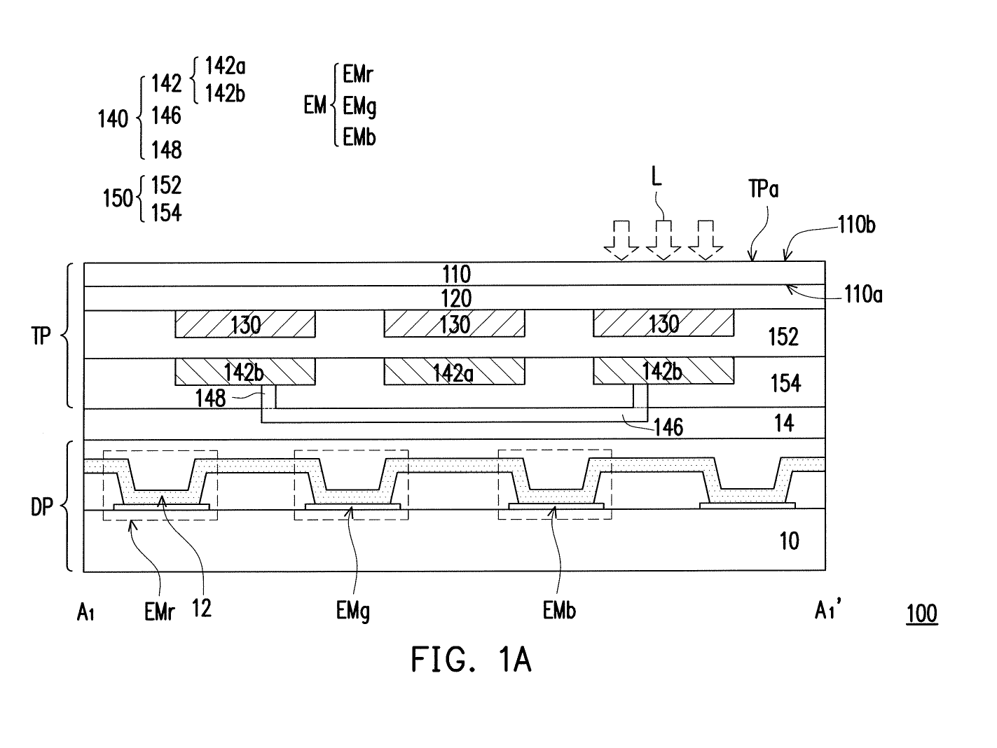

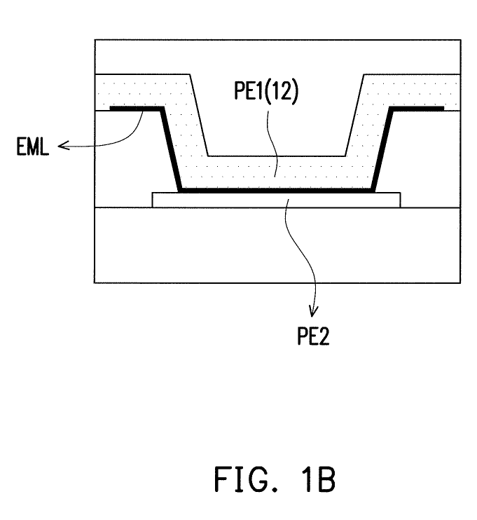

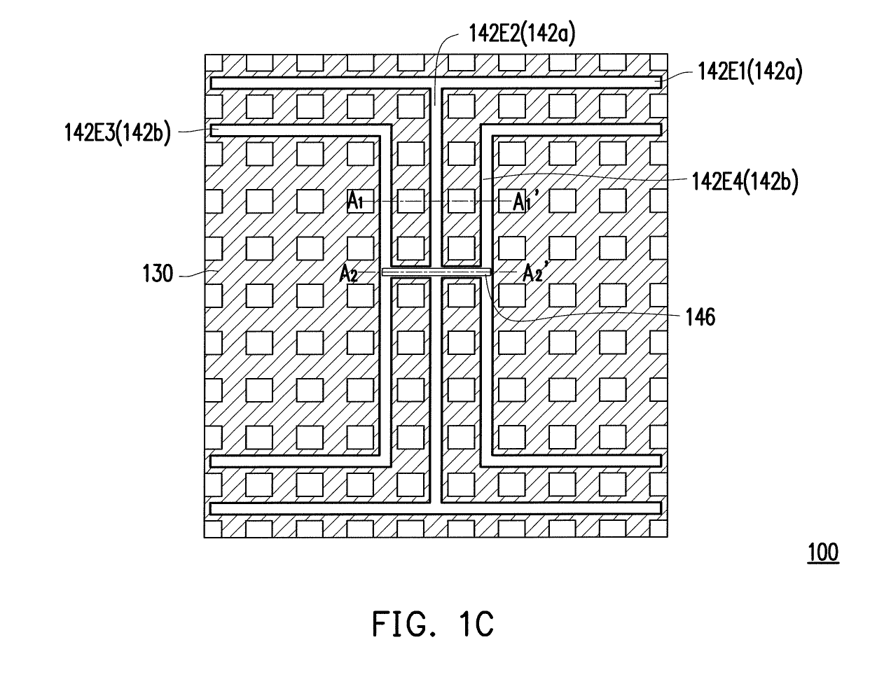

FIG. 1A is a schematic cross-sectional view illustrating a touch-sensing display panel 100 according to a first embodiment of the disclosure, FIG. 1C is a schematic bottom view illustrating the touch-sensing display panel 100 according to the first embodiment of the disclosure, and FIG. 1A is a schematic cross-sectional view along a cross-sectional line A1-A1′ in FIG. 1C. In FIG. 1A, even though a touch-sensing bridge 146 and a conductive via 148 are not located on the cross-sectional line A1-A1′ but on a cross-sectional line A2-A2′, projected regions of the touch-sensing bridge 146 and the conductive via 148 are still shown in this embodiment to indicate relative positions between the touch-sensing bridge 146, the conductive via 148, and a filter layer 130. The touch-sensing display panel 100 of this embodiment includes a display panel DP, an adhesive layer 14, and a touch-sensing panel TP. The adhesive layer 14 is located between the display panel DP and the touch-sensing panel TP and configured to adhere the display panel DP and the touch-sensing panel TP to form the touch-sensing display panel 100. It should be noted that the disclosure does not intend to impose a limitation on a thickness of the adhesive layer 14 and how the adhesive layer 14 adheres. As shown in FIG. 1A, the touch-sensing device layer 140 of the touch-sensing panel TP is formed by a plurality of touch-sensing conductive layers electrically insulated from one another, and the touch-sensing conductive layers may be conductive thin films (e.g. transparent conductive oxide layers) formed over a side of the first substrate 110. In some alternative embodiments, the touch-sensing device layer 140 of the touch-sensing panel TP may be formed over two opposite sides of the first substrate 110 and electrically insulated from each other by the substrate 110.

The display panel DP has a reflective layer 12. The reflective layer 12 may be a reflective electrode or a transflective electrode capable of reflecting light and conducting electricity. In other embodiments, the reflective layer 12 may be a reflective film or a transflective film without the property of being electrically conductive. In other embodiments, the reflective layer 12 may also be formed by films stacked with respective each other, so as to reflect light by utilizing the difference in refractive index between films.

The display panel DP has a light emitting region EM. The light emitting region EM is located on a second substrate 10 and includes a plurality of first light emitting regions EMr, a plurality of second light emitting regions EMg, and a plurality of third light emitting regions EMb. In this embodiment, the first light emitting regions EMr, the second light emitting regions EMg, the third light emitting regions EMb respectively emit light of different colors (e.g., red light, blue light, and green light). Taking pixels of three primary colors as an example, a pixel at least includes a red sub-pixel having the first light-emitting region EMr, at least one green sub-pixel having the second light-emitting region EMg, and at least one blue sub-pixel having the third light emitting region EMb.

Referring to FIG. 1B, FIG. 1B is a partially enlarged schematic view illustrating the light emitting region EM of FIG. 1A. In this embodiment, the second substrate 10 includes a plurality of active devices (not shown), a plurality of scan lines (not shown), and a plurality of data lines (not shown). In addition, the scan lines and data lines intersect each other, so as to define regions where respective sub-pixels (not shown) are located. In addition, a pixel array (not shown) is formed by arranging the sub-pixels as an array. Each sub-pixel includes the corresponding light emitting region EM and active device. In addition, the light emitting region EM has a first pixel electrode PE1, a second pixel electrode PE2, and a light emitting layer EML. Moreover, each active device is electrically connected with the corresponding scan line and data line, and driven by electrical signals transmitted via the corresponding one of the scan lines and one of the data lines. In this embodiment, the active device is a thin film transistor or other switching elements having three terminals, for example. Taking the thin film transistor as an example, a gate (not shown) of the thin film transistor is electrically connected to the corresponding scan line, a source (not shown) of the thin film transistor is electrically connected to the corresponding data line, and a drain (not shown) of the thin film transistor is electrically connected to the second pixel electrode PE2. The first pixel electrode PE1 of each sub-pixel may be configured to drive a display medium layer or a light emitting layer EML. In this embodiment, the first pixel electrode PE1 may be a common electrode, and may be grounded or electrically connected to a common voltage VSS.

In this embodiment, the first pixel electrode PE1 may be distributed on the second substrate 10, and is a transflective conductive layer, for example, and the light emitting layer EML is an organic light emitting diode, for example. In addition, the first pixel electrode PE1, the light emitting layer EML, and the second pixel electrode PE2 may form a structure having a micro-cavity, for example, so as to improve the light emitting efficiency of the light emitting region EM and the coherence of light with color emitted by the light emitting region EM. In this embodiment, a material of the first pixel electrode PE1 includes a magnesium-silver alloy, for example, and a material of the second pixel electrode PE2 includes indium tin oxide (ITO), for example. However, the disclosure is not limited thereto.

The touch-sensing panel TP has a touch-sensing surface TPa, and the touch-sensing panel TP includes filter layers 130, a gray film 120, and a touch-sensing device layer 140. In addition, the filter layers 130 are located between the gray film 120 and the touch-sensing device layer 140. Light transmitted from the touch-sensing surface TPa toward the touch-sensing panel TP and the display panel DP may be reflected by the reflective layer 12, an optical density ratio between the filter layer 130 and the gray film 120 with respect to visible light is N, and N is between 1 and 40. Light emitted by the light emitting region EM of the display panel DP allows an image generated by the display panel DP to be viewed through the touch-sensing surface TPa of the touch-sensing panel TP after the light emitted by the light emitting region EM of the display panel DP passes through the touch-sensing panel TP. Ambient light L may also enter the touch-sensing panel TP and the display panel DP from the touch-sensing surface TPa of the touch-sensing panel TP. However, the ambient light entering the display panel DP may be reflected by the reflective layer 12 in the display panel DP and emitted from the touch-sensing surface TPa of the touch-sensing panel TP. The light emitted by the light emitting region EM of the display panel DP, the ambient light L entering the display panel DP, and the ambient light L reflected by the reflective layer 12 of the display panel DP may be absorbed by the filter layers 130 or the gray film 120. The optical density ratio between the filter layer 130 and the gray film 120 with respect to visible light is N, and N is between 1 and 40. In other words, compared with the gray film 120, the filter layer 130 exhibits a higher light blocking effect, or the gray film 120 exhibits a higher light transmittance than that of the filter layer 130.

In this embodiment, the touch-sensing panel TP further includes a first substrate 110, and the filter layers 130, the gray film 120, and the touch-sensing device layer 140 are disposed on the first substrate 110. The first substrate 110 has a first surface 110a and a second surface 110b opposite to the first surface 110a. The filter layers 130, the gray film 120, and the touch-sensing device layer 140 are stacked on the first surface 110a of the first substrate 110, and the second surface 110b of the first substrate 110 may be the touch-sensing surface TPa. The first substrate 110 may be a rigid or flexible substrate allowing transmittance of visible light. For example, a material of the rigid substrate includes glass or other rigid materials, for example, and a material of the flexible substrate includes polyethylene terephthalate (PET), polyimide (PI), polycarbonate (PC), polyamide (PA), polyethylene naphthalate (PEN), polyethylenimine (PEI), polyurethane (PU), polydimethylsiloxane (PDMS), an acrylic-based polymer (e.g., polymethylmethacrylate, PMMA), an ether-based polymer (e.g., polyethersulfone, PES or polyetheretherketone, PEEK), polyolefin, or other flexible materials, for example. However, the disclosure is not limited thereto. The first substrate 110 may further includes an inorganic particle, such as silica, alumina, zirconium oxide, vanadium oxide, chromium oxide, iron oxide, antimony oxide, tin oxide, titania, or a combination thereof, for example.

The sub-pixels may be arranged as an array, and a pitch is maintained between any two adjacent pixels. In addition, the filter layers 130 correspond to positions between the sub-pixels to avoid light leakage. Moreover, the filter layers 130 on the touch-sensing panel TP may locally shield the light reflected by the reflective layer 12 of the display panel DP, so as to reinforce the display quality of the touch-sensing display panel 100. Furthermore, the filter layers 130 on the touch-sensing panel TP may also locally shield light entering the touch-sensing panel TP from the touch-sensing surface TPa of the touch-sensing panel TP, so as to reinforce the display quality of the touch-sensing display panel 100. In an embodiment, the filter layers 130 may be a black matrix (BM). As an example, the black matrix layer may be manufactured by forming a black matrix material layer and then performing a photolithography process or a photolithography process and an etching process on the black matrix material layer. A material of the black matrix layer includes a filter resin, and the black matrix layer may be formed by performing a photolithography process. The material of the black matrix layer may also be chromium metal or other metal having a light absorbing property, and the black matrix may be formed by performing a photolithography process and an etching process. In other embodiments, the filter layer 130 may be a filter ink layer. Here, the black matrix may be manufactured by printing a polyester-based ink having a filter property, for example.

The gray film 120 may be formed on the touch-sensing panel TP by covering the touch-sensing panel TP, and the gray film 120 may absorb a part of the light. When the light emitting region EM of the display panel DP emits light, a part of the light emitted by the light emitting region EM may be transmitted through the gray film 120 and partially absorbed by the gray film 120. A transmittance rate of the gray film 120 may be adjusted by adjusting a material or a thickness of the gray film 120. The gray film 120 on the touch-sensing panel TP may absorb light leakage of the touch-sensing display panel 100, so as to reinforce the display quality of the touch-sensing display panel 100. In an embodiment, the material of the gray film 120 may include metal, and the gray film 120 may be formed by covering a metal layer on the first substrate by performing a sputtering process or an evaporation process. In other embodiments, the gray film 120 may be formed by applying nanoparticles of metal or metal oxide onto the first substrate 110 by performing a sputtering process, an evaporation process, a coating process, or a sol-gel process. In other embodiments, the material of the gray film 120 includes a carbon-based material. The gray film 120 may be formed by encapsulating carbon powder, carbon-containing particles, or carbon-containing black pigment with acrylic or other media. In other embodiments, the material of the gray film 120 includes a silicon-doped carbon-based material, and the gray film 120 may be formed on a substrate by performing a chemical vapor deposition (CVD) process.

In an embodiment, the gray film 120 and the filter layer 130 may be formed of the same material but have different thicknesses. In other embodiments, the gray film 120 and the filter layer 130 may be formed of different materials and have the same or different thicknesses.

The touch-sensing device layer 140 is configured to detect a signal generated when the user touches the touch-sensing display panel 100. Such signal may be a change of capacitance, a change of resistance, or the like. Taking capacitive touch sensing as an example, when the user touches the touch-sensing display panel 100, a touched region of the touch-sensing device layer 140 may generate a change of capacitance. The change of capacitance may be detected and identified by a controller connected with the touch-sensing device layer 140. In this embodiment, the touch-sensing device layer 140 includes touch-sensing conductive layers 142. In addition, the touch-sensing conductive layers 142 are disposed on the filter layers 130. In an embodiment, the touch-sensing conductive layers 142 have a first projection area on the touch-sensing surface TPa. Regions where projections of the touch-sensing conductive layers 142 and the filter layers 130 on the touch-sensing surface TPa overlap each other have a second projection area. In addition, a ratio between the first projection area and the second projection area is greater than or equal to 70% The touch-sensing conductive layers 142 include first touch-sensing conductive layers 142a and second touch-sensing conductive layers 142b electrically insulated from each other. In addition, a dielectric layer 150 is provided between the first touch-sensing conductive layers 142a and the second touch-sensing conductive layers 142b, such that the first touch-sensing conductive layers 142a and the second touch-sensing conductive layers 142b are electrically insulated from each other. The dielectric layer 150 may be formed of an inorganic material. The inorganic material may include SiOx, SiNx, SiON, AlOx, AlON, or other similar materials. In an embodiment, the dielectric layer 150 may be formed of an organic material. The organic material may include polyimide (PI), polycarbonate (PC), polyamide (PA), polyethylene terephthalate (PET), polyethylene naphthalate (PEN), polyethylenimine (PEI), polyurethane (PU), polydimethylsiloxane (PDMS), an acrylic-based polymer (e.g., polymethylmethacrylate, PMMA), an ether-based polymer (e.g., polyethersulfone, PES or polyetheretherketone, PEEK), polyolefin, other similar materials, or a combination thereof. In other embodiments, the dielectric layer 150 may be formed by alternately stacking organic and inorganic layers or formed of a hybrid material of organic and inorganic materials. Specifically, the dielectric layer 150 of this embodiment includes a first dielectric layer 152 and a second dielectric layer 154. The first dielectric layer 152 is formed between the touch-sensing conductive layers 142 and the filter layers 130 and between the respective filter layers 130, and is configured to separate the touch-sensing conductive layers 142 and the filter layers 130 as well as the respective filter layers. The second dielectric layer 154 is formed between the touch-sensing conductive layers 142 and the adhesive layer 14 and between the first touch-sensing conductive layers 142a and the second touch-sensing conductive layers 142b. The second dielectric layer 154 may be configured to separate the touch-sensing conductive layer 142 and the adhesive layer 14 and separate the first touch-sensing conductive layers 142a and the second touch-sensing conductive layers 142b.

In this embodiment, the dielectric layer 150 may have a flat surface, so that a device formed subsequently may be formed on the flat surface. In other embodiments, the dielectric layer 150 may serve to block permeation of oxygen and/or moisture. Under a circumstance that the touch-sensing display panel 100 is a flexible touch-sensing display panel 100, it is challenging in packaging the touch-sensing panel TP and the display panel DP due to the flexibility of the substrate in addition to issues encountered in the process of manufacturing the touch-sensing display panel 100 with the flexible substrate. For example, in the rigid touch-sensing display panel 100, the rigid substrate may block oxygen and moisture in the air, for example, thereby preventing oxygen and moisture from damaging the touch-sensing panel TP or the display panel DP. However, a blocking ability of the flexible substrate formed of the flexible material may not suffice to satisfy blocking requirements of the touch-sensing panel TP or the display panel DP during the packaging process. Under such circumstance, the dielectric layer 150 capable of blocking permeation of oxygen and/or moisture, for example, may be used to prevent oxygen and/or moisture from permeating the flexible substrate to affect the touch-sensing panel TP or the display panel DP. In addition to the dielectric layer 150, the gray film 120 also needs to have a blocking ability. Based on the needs, the dielectric layer 150 or the gray film 120 may be disposed between the layers described in the respective embodiments of the disclosure.

To more specifically describe the embodiment, FIG. 1C is a schematic bottom view illustrating the touch-sensing display panel 100 according to the first embodiment of the disclosure. For the purpose of clear illustration, some layers are omitted in FIG. 1C. In this embodiment, the first touch-sensing conductive layer 142a includes a first touch-sensing electrode 142E1 having the same extending direction and a second touch-sensing electrode 142E2 having the same extending direction, for example. In addition, the extending direction of the first touch-sensing electrode 142E1 may be substantially perpendicular to the extending direction of the second touch-sensing electrode 142E2. The second touch-sensing conductive layer 142b has a third touch-sensing electrode 142E3 having the same extending direction and a fourth touch-sensing electrode 142E4 having the same extending direction, for example. In addition, the extending direction of the third touch-sensing electrode 142E3 may be substantially perpendicular to the extending direction of the fourth touch-sensing electrode 142E4, the extending direction of the first touch-sensing electrode 142E1 may be substantially parallel to the extending direction of the third touch-sensing electrode 142E3, and the extending direction of the second touch-sensing electrode 142E2 may be substantially parallel to the extending direction of the fourth touch-sensing electrode 142E4. In this embodiment, the touch-sensing device layer 140 further includes a plurality of the conductive vias 148 and a plurality of the touch-sensing bridge 146. The conductive vias 148 penetrate through the second dielectric layer 154. In addition, the second dielectric layer 154 is located between the touch-sensing bridge 146 and the touch-sensing conductive layers 142. In an embodiment, vias are formed in the second dielectric layer 154 by etching, grind-drilling, laser drilling, or other suitable processes. Then, a conductive material is filled into the vias to form the conductive vias 148 in the second dielectric layer 154. Each second touch-sensing conductive layer 142b is connected to one of the touch-sensing bridge 146 on the second dielectric layer 154 through the corresponding conductive via 148. Thus, each second touch-sensing conductive layer 142b may be electrically connected to the corresponding touch-sensing bridge 146 through the corresponding conductive via 148.

In an embodiment, the touch-sensing display panel 100 may further include a substrate protection structure. The substrate protection structure is disposed on the touch-sensing surface TPa. A material of the substrate protection structure includes reinforced glass or quartz glass, for example, and a rigidity of the substrate protection structure is higher than 1H, for example, so as to prevent abrasion or impact to the touch-sensing panel TP.

In the following, different embodiments are provided to describe the touch-sensing display panel. It should be noted that the reference numerals and a part of the contents in the previous embodiment are used in the following embodiments, in which identical reference numerals indicate identical or similar components, and repeated description of the same technical contents is omitted. For a detailed description of the omitted parts, reference can be found in the previous embodiment, and no repeated description is contained in the following embodiments.

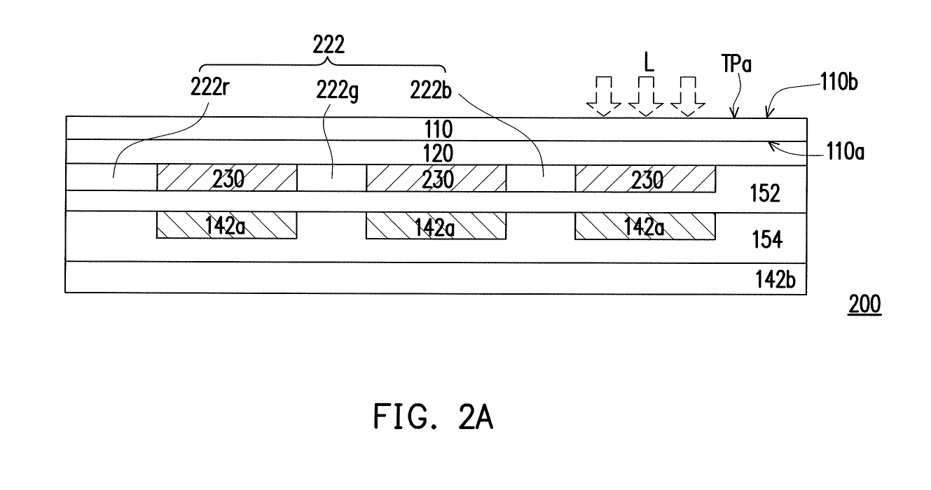

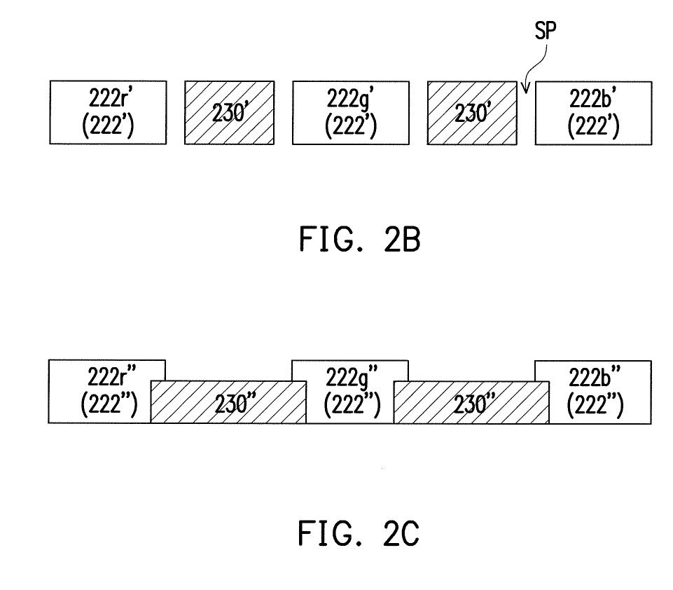

FIG. 2A is a schematic cross-sectional view illustrating a touch-sensing display panel 200 according to a second embodiment of the disclosure. The touch-sensing display panel 200 of the second embodiment is similar to the touch-sensing display panel 100 of FIG. 1A. Here, the touch-sensing panel TP of the touch-sensing display panel 200 of this embodiment is described with reference to FIG. 2A. It should be noted that, in FIG. 2A, like or similar reference numerals represent like or similar components. Thus, components already described in FIG. 1A will not be described in the following.

In this embodiment, a color filter layer 222 may be disposed between respective filter layers 230. In addition, the color filter layer 222 may include a first color filter layer 222r, a second color filter layer 222g, and a third color filter layer 222b that allow light with different colors (e.g., red light, blue light, and green light) to pass through. Taking a common arrangement as an example, each color filter layer 222 on the touch-sensing panel TP may shield light that is not emitted by the corresponding light emitting region EM on the display panel DP, so as to reduce light leakage of the touch-sensing display panel 200 and reinforce the display quality of the touch-sensing display panel 200. Based on the needs, the color filter layer 222 may be disposed in the embodiments of the disclosure.

In an embodiment, the color filter layer 222 may be formed by inkjet printing. The process of formation includes, for example, forming the filter layers 230 with a plurality of openings on a substrate, injecting color inks (e.g., red, green, and blue inks) into the openings of the filter layers 230 by inkjet printing, and then performing a thermal baking process to cure the color inks, thereby forming the color filter layer 222. In the inkjet printing process, the color inks are, for example, pigments, dyes or a combination thereof.

In the touch-sensing display panel 200 of FIG. 2A, the color filter layer 222 may be aligned with edges of the filter layers 230. In other embodiments, the color filter layer 222 may be not aligned with the edges of the filter layers 230. Referring to FIG. 2B, which is a schematic cross-sectional view illustrating a touch-sensing display panel according to an embodiment of the disclosure, and FIG. 2C, which is a schematic cross-sectional view illustrating a touch-sensing display panel according to another embodiment of the disclosure, only some of the layers are illustrated in FIGS. 2B and 2C for clarity of illustration. The touch-sensing display panel in the embodiment of FIG. 2B is similar to the touch-sensing display panel 200 in the embodiment of FIG. 2A. In this embodiment, a color filter layer 222′ is disposed between respective filter layers 230′. In addition, a gap SP are provided between the color filter layer 222′ and the filter layer 230′. Moreover, referring to FIG. 2C, which is a schematic cross-sectional view illustrating a touch-sensing display panel according to another embodiment of the disclosure, the touch-sensing display panel in the embodiment of FIG. 2C is similar to the touch-sensing display panel 200 in the embodiment of FIG. 2A. In this embodiment, a color filter layer 222″ is provided between respective filter layers 230″, and the color filter layer 222″ and the adjacent filter layer 230″ may be partially overlapped.

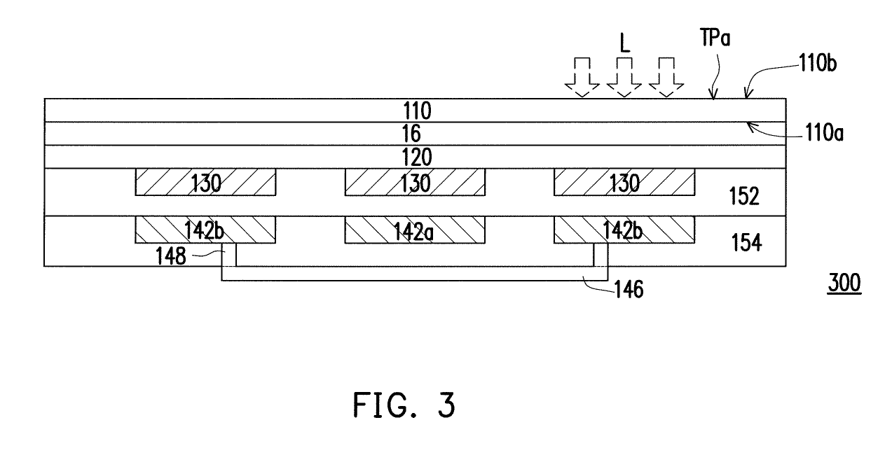

FIG. 3 is a schematic cross-sectional view illustrating a touch-sensing display panel 300 according to a third embodiment of the disclosure. The touch-sensing display panel 300 of the third embodiment is similar to the touch-sensing display panel 100 of FIG. 1A. Here, the touch-sensing panel TP of the touch-sensing display panel 300 of this embodiment is described with reference to FIG. 3. It should be noted that, in FIG. 3, like or similar reference numerals represent like or similar components. Thus, components already described in FIG. 1A will not be described in the following.

In this embodiment, the touch-sensing display panel 300 may further include a barrier layer 16. The barrier layer 16 may be disposed between the first substrate 110 and the adhesive layer 14 or on the second surface 110b of the first substrate 110. In addition, a moisture transmission rate of the barrier layer 16 is lower than or equal to 0.1 g/m²/day, for example. Preferably, the moisture transmission rate of the barrier layer 16 is less than 0.01 g/m²/day. A material of the barrier layer 16 may include an inorganic material, such as SiON, SiNx, SiON, AlON, or the like. In addition, the material of the barrier layer 16 may also include a metallic material, and the metallic material includes molybdenum, titanium, aluminum, chromium, molybdenum/aluminum/molybdenum, titanium/aluminum/titanium, or the like, for example. In this embodiment, the choice on the material of the barrier layer 16 is related to the location where the barrier layer 16 is disposed. People having ordinary skills in the art may properly choose the material of the barrier layer 16 according to the location where the barrier layer 16 is to be disposed, as long as the principle of not causing unexpected short circuits of the touch-sensing conductive layer 142, the touch-sensing panel TP, the display panel DP, the conductive vias 148, and/or the touch-sensing bridge 146 is met. It should be noted that the disclosure does not intend to impose a limitation on the location, number, and configuration of the barrier layer 16. Even though the barrier layer 16 is disposed between the first substrate 110 and the gray film 120 in this embodiment, the barrier layer 16 may also be disposed on the second surface 110b of the first substrate 110, between the gray film 120 and the filter layers 130, between the first dielectric layer 152 and the second dielectric layer 154, and/or between the second dielectric layer 154 and the adhesive layer 14.

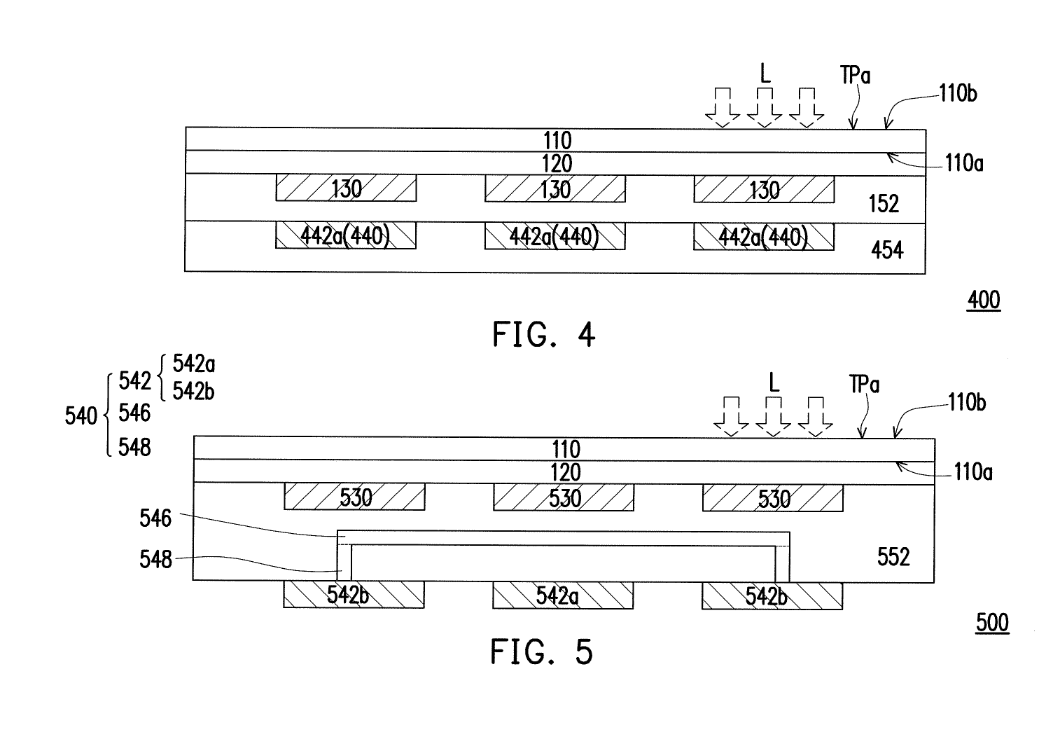

FIG. 4 is a schematic cross-sectional view illustrating a touch-sensing display panel 400 according to a fourth embodiment of the disclosure. The touch-sensing display panel 400 of the fourth embodiment is similar to the touch-sensing display panel 100 of FIG. 1A. Here, the touch-sensing panel TP of the touch-sensing display panel 400 of this embodiment is described with reference to FIG. 4. It should be noted that, in FIG. 4, like or similar reference numerals represent like or similar components. Thus, components already described in FIG. 1A will not be described in the following. In this embodiment, a touch-sensing device layer 440 has a plurality of first touch-sensing conductive layers 442a. In addition, the touch-sensing device layer 440 is configured to detect a signal generated when the user touches the touch-sensing display panel 400. A second dielectric layer 454 is formed between the respective first touch-sensing conductive layers 442a. The second dielectric layer 454 may serve to separate the respective first touch-sensing conductive layers 442a. The filter layers 130 are located between the gray film 120 and the first touch-sensing conductive layers 442a.

FIG. 5 is a schematic cross-sectional view illustrating a touch-sensing display panel 500 according to a fifth embodiment of the disclosure. The touch-sensing display panel 500 of the fifth embodiment is similar to the touch-sensing display panel 100 of FIG. 1A. Here, the touch-sensing panel TP of the touch-sensing display panel 500 of this embodiment is described with reference to FIG. 5. It should be noted that, in FIG. 5, like or similar reference numerals represent like or similar components. Thus, components already described in FIG. 1A will not be described in the following. In this embodiment, a first dielectric layer 552 is formed between touch-sensing conductive layers 542 and filter layers 530, between the respective filter layers 530, and between a first touch-sensing conductive layer 542a and a second touch-sensing conductive layer 542b. The first dielectric layer 552 may separate the touch-sensing conductive layers 542 and the filter layers 530, the respective filter layers 530, and the first touch-sensing conductive layers 542a and the second touch-sensing conductive layers 542b. The touch-sensing device layer 540 further includes a plurality of conductive vias 548 and a plurality of touch-sensing bridges 546. In addition, the touch-sensing bridges 546 are located in the first dielectric layer 552 and between the touch-sensing conductive layers 542 and the filter layers 530. The conductive vias 548 may partially penetrate through the first dielectric layer 552. In addition, the first dielectric layer 552 is located between the touch-sensing bridge 546 and the touch-sensing conductive layer 542. Each second touch-sensing conductive 542b is connected to one of the touch-sensing bridge 546 in the first dielectric layer 552 through the corresponding conductive via 548. Thus, each second touch-sensing conductive layer 542b may be electrically connected to the corresponding touch-sensing bridge 546 through the corresponding conductive via 548.

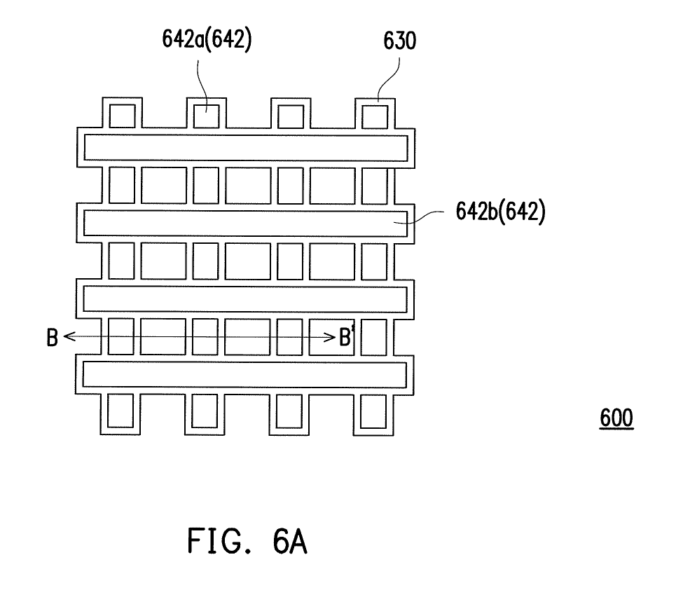

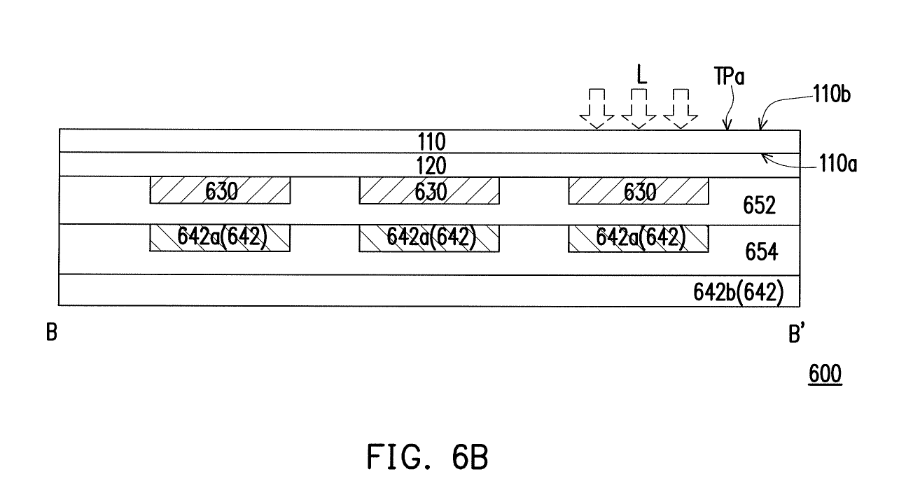

FIG. 6A is a schematic bottom view illustrating a touch-sensing display panel 600 according to a sixth embodiment of the disclosure, and FIG. 6B is a schematic cross-sectional view illustrating the touch-sensing display panel 600 according to the sixth embodiment of the disclosure. For the purpose of clear illustration, some layers are omitted in FIG. 6A. In addition, FIG. 6B is a schematic cross-sectional view along a cross-sectional line B-B′ in FIG. 6A. In FIG. 6A, even though a second touch-sensing conductive layer 642b is not located on the cross-sectional line B-B′, a projected region of the second touch-sensing conductive layer 642b is still shown in this embodiment to indicate relative positions between a first touch-sensing conductive layer 642a, a second touch-sensing conductive layer 642b, and a filter layer 630. The touch-sensing display panel 600 of the sixth embodiment is similar to the touch-sensing display panel 100 of FIG. 1A. Here, the touch-sensing panel TP of the touch-sensing display panel 600 of this embodiment is described with reference to FIGS. 6A and 6B. It should be noted that, in FIGS. 6A and 6B, like or similar reference numerals represent like or similar components. Thus, components already described in FIG. 1A will not be described in the following. In this embodiment, a first dielectric layer 652 is formed between touch-sensing conductive layers 642 and filter layers 630 and between the respective filter layers 630. A second dielectric layer 654 is formed between the respective first touch-sensing conductive layers 642a, between the respective second touch-sensing conductive layers 642b, and between the first touch-sensing conductive layers 642a and the second touch-sensing conductive layers 642b. The first dielectric layer 652 may serve to separate the touch-sensing conductive layers 642 and the filter layers 630 and separate the respective filter layers 630. The second dielectric layer 654 may separate the respective first touch-sensing conductive layers 642a, the respective second touch-sensing conductive layers 642b, and the first touch-sensing conductive layers 642a and the second touch-sensing conductive layers 642b. It should be noted that, in this embodiment, the first touch-sensing conductive layers 642a are located between the filter layers 630 and the second touch-sensing conductive layers 642b, and the first touch-sensing conductive layers 642a and the second touch-sensing conductive layers 642b have different extending directions.

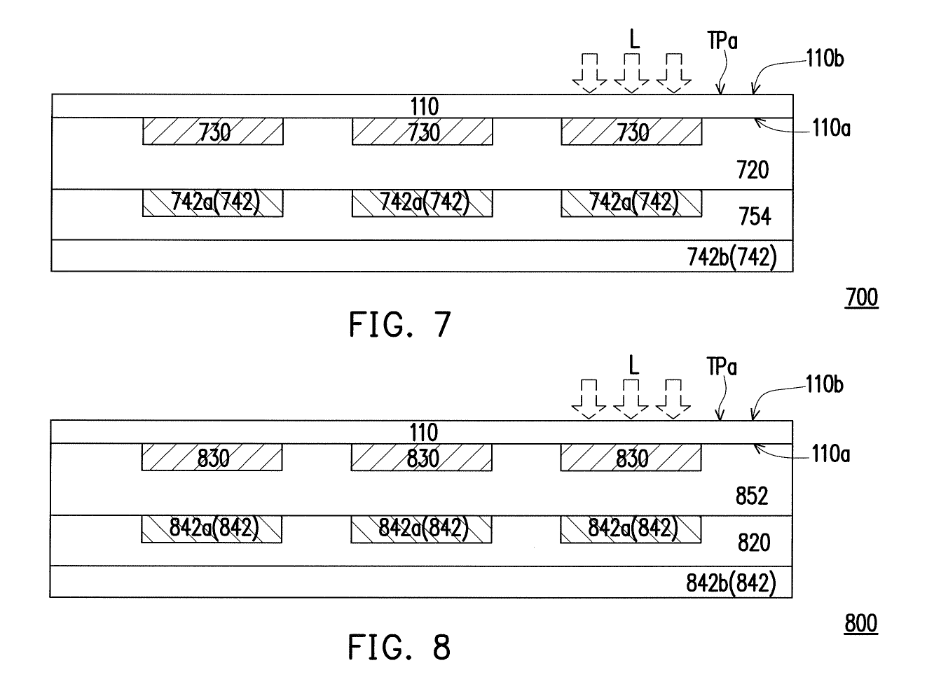

FIG. 7 is a schematic cross-sectional view illustrating a touch-sensing display panel 700 according to a seventh embodiment of the disclosure. The touch-sensing display panel 700 of the seventh embodiment is similar to the touch-sensing display panel 600 of FIG. 6B. Here, the touch-sensing panel TP of the touch-sensing display panel 700 of this embodiment is described with reference to FIG. 7. It should be noted that, in FIG. 7, like or similar reference numerals represent like or similar components. Thus, components already described in FIG. 6B will not be described in the following. In this embodiment, a gray film 720 is formed between a touch-sensing conductive layers 742 and filter layers 730 and between the respective filter layers 730. The gray film 720 may serve to separate the touch-sensing conductive layers 742 and the filter layers 730 and separate the respective filter layers 730. A second dielectric layer 754 is formed between first touch-sensing conductive layers 742a and second touch-sensing conductive layers 742b. The second dielectric layer 754 may separate the respective first touch-sensing conductive layers 742a, the respective second touch-sensing conductive layers 742b, and the first touch-sensing conductive layers 742a and the second touch-sensing conductive layers 742b. In this embodiment, the first touch-sensing conductive layers 742a are located between the filter layers 730 and the second touch-sensing conductive layers 742b, and the first touch-sensing conductive layers 742a and the second touch-sensing conductive layers 742b have different extending directions.

FIG. 8 is a schematic cross-sectional view illustrating a touch-sensing display panel 800 according to an eighth embodiment of the disclosure. The touch-sensing display panel 800 of the eighth embodiment is similar to the touch-sensing display panel 600 of FIG. 6B. Here, the touch-sensing panel TP of the touch-sensing display panel 800 of this embodiment is described with reference to FIG. 8. It should be noted that, in FIG. 8, like or similar reference numerals represent like or similar components. Thus, components already described in FIG. 6B will not be described in the following. In this embodiment, a gray film 820 is formed between respective first touch-sensing conductive layers 842a, between respective second touch-sensing conductive layers 842b, and between the first touch-sensing conductive layers 842a and the second touch-sensing conductive layers 842b. The gray film 820 may separate the respective first touch-sensing conductive layers 842a, the respective second touch-sensing conductive layers 842b, and the first touch-sensing conductive layers 842a and the second touch-sensing conductive layers 842b. A first dielectric layer 852 is formed between the filter layers 830 and the touch-sensing conductive layers 842, and may separate the first touch-sensing conductive layers 842a and the filter layers 830. In this embodiment, the first touch-sensing conductive layers 842a are located between the filter layers 830 and the second touch-sensing conductive layers 842b, and the first touch-sensing conductive layers 842a and the second touch-sensing conductive layers 842b have different extending directions.

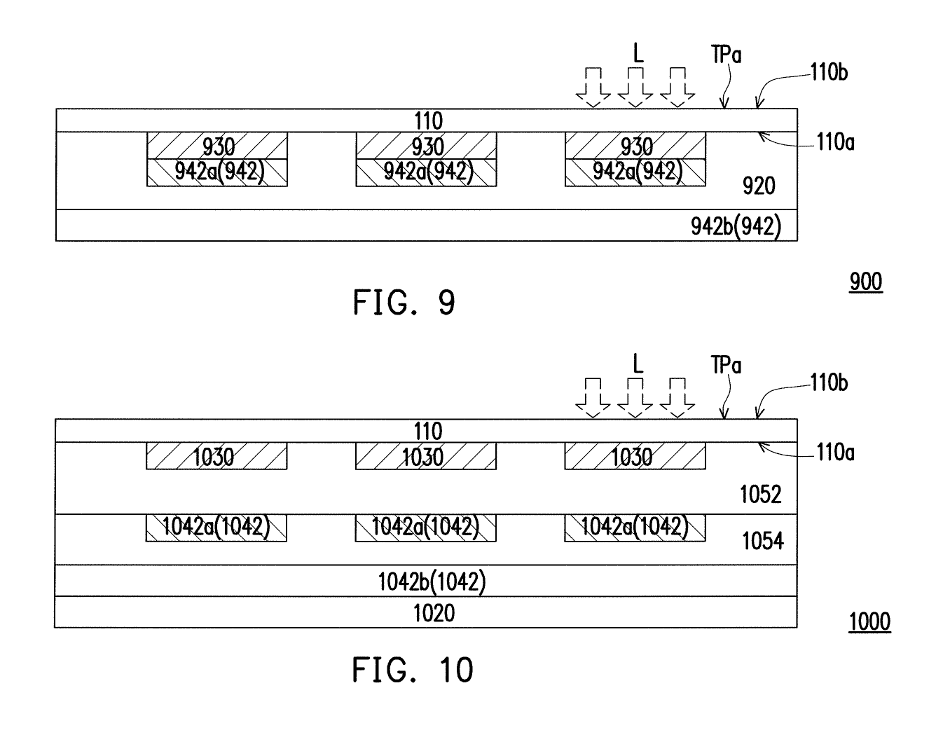

FIG. 9 is a schematic cross-sectional view illustrating a touch-sensing display panel 900 according to a ninth embodiment of the disclosure. The touch-sensing display panel 900 of the ninth embodiment is similar to the touch-sensing display panel 100 of FIG. 1A. Here, the touch-sensing panel TP of the touch-sensing display panel 900 of this embodiment is described with reference to FIG. 9. It should be noted that, in FIG. 9, like or similar reference numerals represent like or similar components. Thus, components already described in FIG. 1A will not be described in the following. In this embodiment, first touch-sensing conductive layers 942a are disposed on filter layers 930, and the filter layers 930 are located between the first touch-sensing conductive layers 942a and the first substrate 110. A gray film 920 is formed between the respective filter layers 930, between the respective first touch-sensing conductive layers 942a, between respective second touch-sensing conductive layers 942b, and between the first touch-sensing conductive layers 942a and the second touch-sensing conductive layers 942b. The gray film 920 may separate the respective filter layers 930, the respective first touch-sensing conductive layers 942a, the respective second touch-sensing conductive layers 942b, and the first touch-sensing conductive layers 942a and the second touch-sensing conductive layers 942b. In this embodiment, the first touch-sensing conductive layers 942a are located between the filter layers 930 and the second touch-sensing conductive layers 942b, and the first touch-sensing conductive layers 942a and the second touch-sensing conductive layers 942b have different extending directions.

FIG. 10 is a schematic cross-sectional view illustrating a touch-sensing display panel 1000 according to a tenth embodiment of the disclosure. The touch-sensing display panel 1000 of the tenth embodiment is similar to the touch-sensing display panel 600 of FIG. 6B. Here, the touch-sensing panel TP of the touch-sensing display panel 1000 of this embodiment is described with reference to FIG. 10. It should be noted that, in FIG. 10, like or similar reference numerals represent like or similar components. Thus, components already described in FIG. 6B will not be described in the following. In this embodiment, filter layers 1030 and a first dielectric layer 1052 are disposed on the first surface 110a of the first substrate 110, and touch-sensing conductive layers 1042 are located between a gray film 1020 and the filter layers 1030. A second dielectric layer 1054 is formed between first touch-sensing conductive layers 1042a and second touch-sensing conductive layers 1042b. The second dielectric layer 1054 may separate the respective first touch-sensing conductive layers 1042a, the respective second touch-sensing conductive layers 1042b, and the first touch-sensing conductive layers 1042a and the second touch-sensing conductive layers 1042b. In this embodiment, the first touch-sensing conductive layers 1042a are located between the filter layers 1030 and the second touch-sensing conductive layers 1042b, and the first touch-sensing conductive layers 1042a and the second touch-sensing conductive layers 1042b have different extending directions.

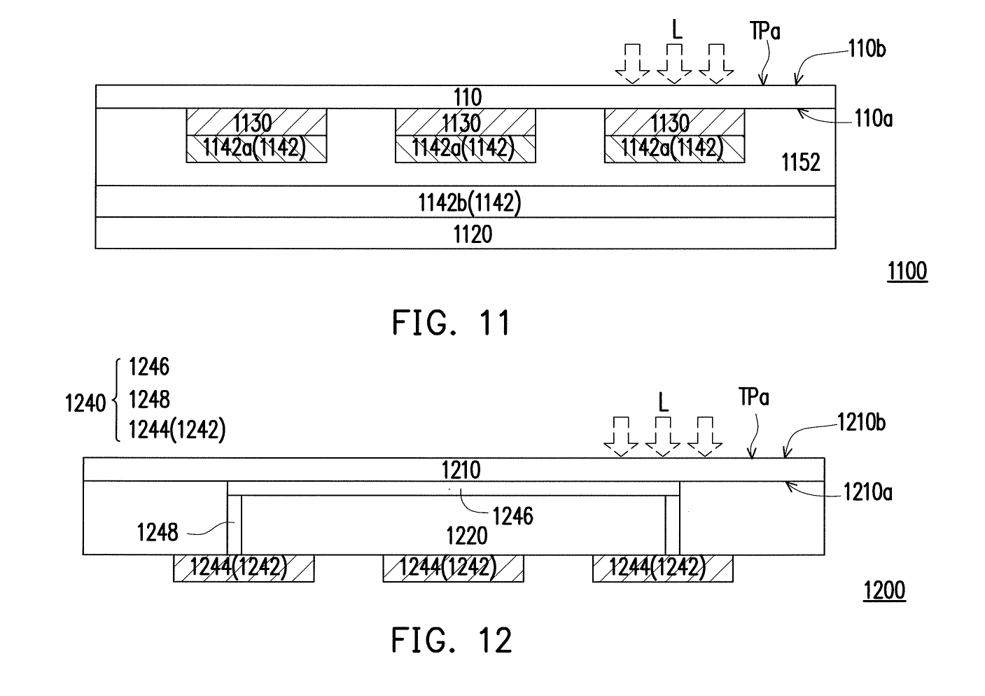

FIG. 11 is a schematic cross-sectional view illustrating a touch-sensing display panel 1100 according to an eleventh embodiment of the disclosure. The touch-sensing display panel 1100 of the eleventh embodiment is similar to the touch-sensing display panel 1000 of FIG. 10. Here, the touch-sensing panel TP of the touch-sensing display panel 1100 of this embodiment is described with reference to FIG. 11. It should be noted that, in FIG. 11, like or similar reference numerals represent like or similar components. Thus, components already described in FIG. 6B will not be described in the following. In this embodiment, first touch-sensing conductive layers 1142a are disposed on filter layers 1130, and the filter layers 1130 are located between the first touch-sensing conductive layers 1142a and the first substrate 110. A first dielectric layer 1152 is formed between the respective filter layers 1130, between the respective first touch-sensing conductive layers 1142a, between respective second touch-sensing conductive layers 1142b, and between the first touch-sensing conductive layers 1142a and the second touch-sensing conductive layers 1142b. The first dielectric layer 1152 may separate the respective filter layers 1130, the respective first touch-sensing conductive layers 1142a, the respective second touch-sensing conductive layers 1142b, and the first touch-sensing conductive layers 1142a and the second touch-sensing conductive layers 1142b. In this embodiment, the first touch-sensing conductive layers 1142a are located between the filter layers 1130 and the second touch-sensing conductive layers 1142b, and the first touch-sensing conductive layers 1142a and the second touch-sensing conductive layers 1142b have different extending directions.

FIG. 12 is a schematic cross-sectional view illustrating a touch-sensing display panel 1200 according to a twelfth embodiment of the disclosure. The touch-sensing display panel 1200 of the twelfth embodiment is similar to the touch-sensing display panel 100 of FIG. 1A. Here, the touch-sensing panel TP of the touch-sensing display panel 1200 of this embodiment is described with reference to FIG. 12. It should be noted that, in FIG. 12, like or similar reference numerals represent like or similar components. Thus, components already described in FIG. 1A will not be described in the following. In this embodiment, a touch-sensing device layer 1240 includes a plurality of filter touch-sensing conductive layers 1244. The filter touch-sensing conductive layers 1244 of the touch-sensing panel TP correspond to positions between the sub-pixels of the display panel DP to avoid light leakage. Moreover, the filter touch-sensing conductive layers 1244 on the touch-sensing panel TP may locally shield the light reflected by the reflective layer 12 of the display panel DP, so as to reinforce the display quality of the touch-sensing display panel 1200. It should be noted that, in this embodiment, the filter touch-sensing conductive layers 1244 are conductive. Thus, a part of the filter touch-sensing conductive layers 1244 may also serve as touch-sensing conductive layers 1242. The part of the touch-sensing conductive layers 1244 may further transmit an electronic signal in addition to receiving light, so as to be adapted to sense an electrical change generated by the user's touch. Thus, light transmitted toward the touch-sensing panel TP from the touch-sensing surface TPa becomes transmitted light and does not generate any reflection from irradiation to the touch-sensing conductive layers 1242. Thus, the image displayed by the display panel DP and observed from outside through the touch-sensing surface TPa of the touch-sensing panel TP does not include reflected light irradiated from the touch-sensing conductive layers 1242. Consequently, the display quality of the touch-sensing display panel 1200 may be reinforced.

In this embodiment, a gray film 1220 is located between the filter touch-sensing conductive layers 1244 and the first substrate 1210, and a part of the filter touch-sensing conductive layers 1244 may serve as the touch-sensing conductive layers 1242. The touch-sensing device layer 1240 further includes a plurality of conductive vias 1248 and a plurality of touch-sensing bridges 1246. In addition, the touch-sensing bridges 1246 are located between the gray film 1220 and the first substrate 1210, and the conductive vias 1248 may penetrate through the gray film 1220. In this embodiment, vias are formed in the gray film 1220 by etching, grind-drilling, laser drilling, or other suitable processes. Then, a conductive material is filled into the vias to form the conductive vias 1248 in the gray film 1220. The part of the filter touch-sensing conductive layers 1244 serving as the touch-sensing conductive layers 1242 are respectively electrically connected to one of the touch-sensing bridges 1246 in the gray film 1220 through the corresponding conductive via 1248. Thus, each touch-sensing conductive layer 1242 may be electrically connected to the corresponding bridge conductive 1246 through the corresponding conductive via 1248.

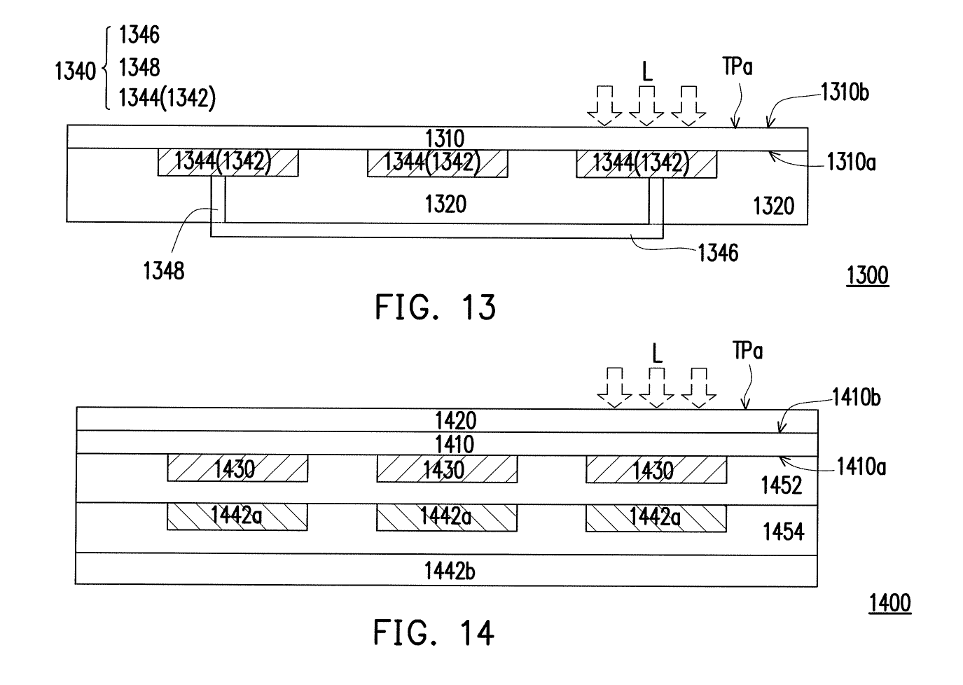

FIG. 13 is a schematic cross-sectional view illustrating a touch-sensing display panel 1300 according to a thirteenth embodiment of the disclosure. The touch-sensing display panel 1300 of the thirteenth embodiment is similar to the touch-sensing display panel 1200 of FIG. 12. Here, the touch-sensing panel TP of the touch-sensing display panel 1300 of this embodiment is described with reference to FIG. 13. It should be noted that, in FIG. 13, like or similar reference numerals represent like or similar components. Thus, components already described in FIG. 12 will not be described in the following. In this embodiment, filter touch-sensing conductive layers 1344 are located between a gray film 1320 and a first substrate 1310, and a part of filter touch-sensing conductive layers 1344 may serve as touch-sensing conductive layers 1342. A touch-sensing device layer 1340 further includes a plurality of conductive vias 1348 and a plurality of touch-sensing bridges 1346. In addition, the gray film 1320 is located between touch-sensing bridges 1346 and a first substrate 1310, and conductive vias 1348 may penetrate through the gray film 1320. In this embodiment, vias are formed in the gray film 1320 by etching, grind-drilling, laser drilling, or other suitable processes. Then, a conductive material is filled into the vias to form the conductive vias 1348 in the gray film 1320. The part of the filter touch-sensing conductive layers 1344 serving as the touch-sensing conductive layers 1342 are respectively electrically connected to one of the touch-sensing bridges 1346 in the gray film 1320 through the corresponding conductive via 1348. Thus, each touch-sensing conductive layer 1342 may be electrically connected to the corresponding touch-sensing bridge 1346 through the corresponding conductive via 1348.

FIG. 14 is a schematic cross-sectional view illustrating a touch-sensing display panel 1400 according to a fourteenth embodiment of the disclosure. The touch-sensing display panel 1400 of the fourteenth embodiment is similar to the touch-sensing display panel 600 of FIG. 6B. Here, the touch-sensing panel TP of the touch-sensing display panel 1400 of this embodiment is described with reference to FIG. 14. It should be noted that, in FIG. 14, like or similar reference numerals represent like or similar components. Thus, components already described in FIG. 6B will not be described in the following. In this embodiment, a gray film 1420 is located on a second surface 1410b of a first substrate 1410. The first substrate 1410 is located between filter layers 1430 and the gray film 1420. In addition, the second surface 1410b of the first substrate 1410 is not the touch-sensing surface TPa.

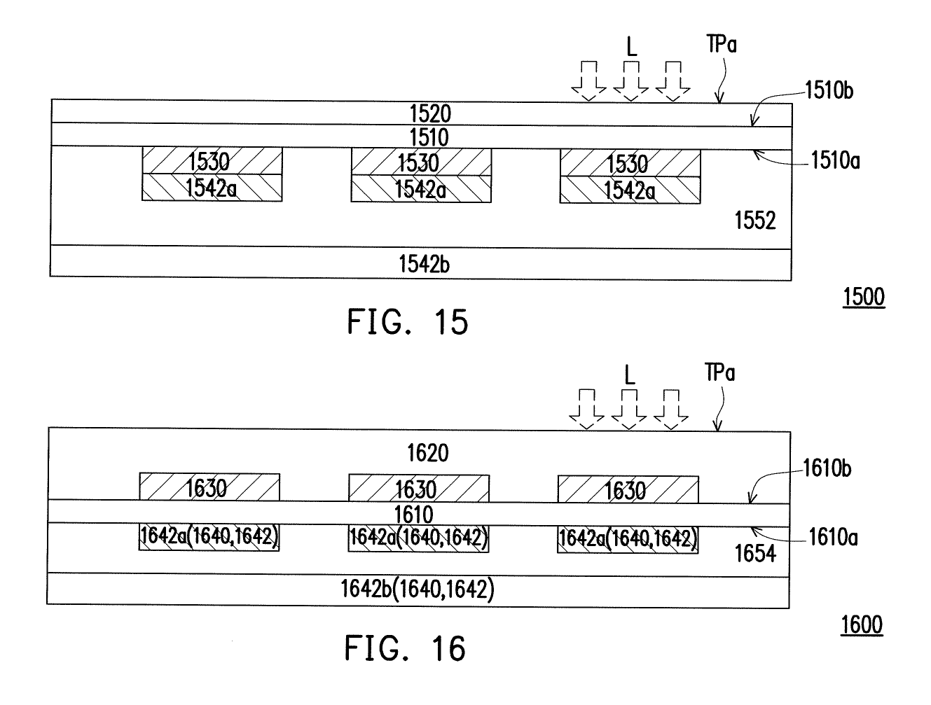

FIG. 15 is a schematic cross-sectional view illustrating a touch-sensing display panel 1500 according to a fifteenth embodiment of the disclosure. The touch-sensing display panel 1500 of the fifteenth embodiment is similar to the touch-sensing display panel 1100 of FIG. 11. Here, the touch-sensing panel TP of the touch-sensing display panel 1500 of this embodiment is described with reference to FIG. 15. It should be noted that, in FIG. 15, like or similar reference numerals represent like or similar components. Thus, components already described in FIG. 11 will not be described in the following. In this embodiment, a gray film 1520 is located on a second surface 1510b of a first substrate 1510. The first substrate 1510 is located between filter layers 1530 and the gray film 1520. In addition, the second surface 1510b of the first substrate 1510 is not the touch-sensing surface TPa.

FIG. 16 is a schematic cross-sectional view illustrating a touch-sensing display panel 1600 according to a sixteenth embodiment of the disclosure. The touch-sensing display panel 1600 of the sixteenth embodiment is similar to the touch-sensing display panel 600 of FIG. 6B. Here, the touch-sensing panel TP of the touch-sensing display panel 1600 of this embodiment is described with reference to FIG. 16. It should be noted that, in FIG. 16, like or similar reference numerals represent like or similar components. Thus, components already described in FIG. 6B will not be described in the following. In this embodiment, touch-sensing device layers 1640 are disposed on a first surface 1610a of a first substrate 1610. Filter layers 1630 and a gray film 1620 are stacked on a second surface 1610b of the first substrate 1610. The filter layers 1630 are located between the gray film 1620 and the first substrate 1610, and the first substrate 1610 is located between the filter layers 1630 and the touch-sensing device layers 1640. Touch-sensing conductive layers 1642 include first touch-sensing conductive layers 1642a and second touch-sensing conductive layers 1642b electrically insulated from each other. In addition, a second dielectric layer 1654 is provided between the first touch-sensing conductive layers 1642a and the second touch-sensing conductive layers 1642b, such that the first touch-sensing conductive layers 1642a and the second touch-sensing conductive layers 1642b are electrically insulated from each other. In this embodiment, the first touch-sensing conductive layers 1642a is located between the filter layers 1630 and the second touch-sensing conductive layers 1642b, and the first touch-sensing conductive layers 1642a and the second touch-sensing conductive layers 1642b have different extending directions.

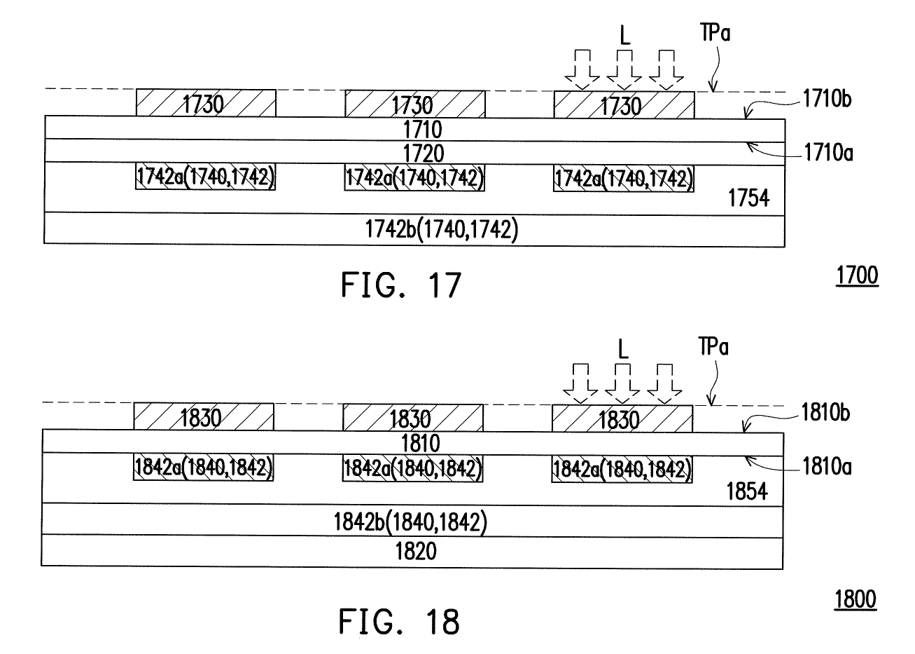

FIG. 17 is a schematic cross-sectional view illustrating a touch-sensing display panel 1700 according to a seventeenth embodiment of the disclosure. The touch-sensing display panel 1700 of the seventeenth embodiment is similar to the touch-sensing display panel 1600 of FIG. 16. Here, the touch-sensing panel TP of the touch-sensing display panel 1700 of this embodiment is described with reference to FIG. 17. It should be noted that, in FIG. 17, like or similar reference numerals represent like or similar components. Thus, components already described in FIG. 16 will not be described in the following. In this embodiment, touch-sensing device layers 1740 and a gray film 1720 are disposed on a first surface 1710a of a first substrate 1710. Filter layers 1730 are stacked on a second surface 1710b of the first substrate 1710. The first substrate 1710 is located between the filter layers 1730 and the gray film 1720, and the gray film 1720 is located between the first substrate 1710 and the touch-sensing device layers 1740. Touch-sensing conductive layers 1742 include first touch-sensing conductive layers 1742a and second touch-sensing conductive layers 1742b electrically insulated from each other. In addition, a second dielectric layer 1754 is provided between the first touch-sensing conductive layers 1742a and the second touch-sensing conductive layers 1742b, such that the first touch-sensing conductive layers 1742a and the second touch-sensing conductive layers 1742b are electrically insulated from each other. In this embodiment, the first touch-sensing conductive layers 1742a are located between the filter layers 1730 and the second touch-sensing conductive layers 1742b, and the first touch-sensing conductive layers 1742a and the second touch-sensing conductive layers 1742b have different extending directions.

FIG. 18 is a schematic cross-sectional view illustrating a touch-sensing display panel 1800 according to an eighteenth embodiment of the disclosure. The touch-sensing display panel 1800 of the eighteenth embodiment is similar to the touch-sensing display panel 1700 of FIG. 17. Here, the touch-sensing panel TP of the touch-sensing display panel 1800 of this embodiment is described with reference to FIG. 18. It should be noted that, in FIG. 18, like or similar reference numerals represent like or similar components. Thus, components already described in FIG. 17 will not be described in the following. In this embodiment, touch-sensing device layers 1840 and a gray film 1820 are disposed on a first surface 1810a of a first substrate 1810. Filter layers 1830 are stacked on a second surface 1810b of the first substrate 1810. The first substrate 1810 is located between the filter layers 1830 and the touch-sensing device layers 1840, and the touch-sensing device layers 1840 are located between the first substrate 1810 and the gray film 1820. Touch-sensing conductive layers 1842 include first touch-sensing conductive layers 1842a and second touch-sensing conductive layers 1842b electrically insulated from each other. In addition, a second dielectric layer 1854 is provided between the first touch-sensing conductive layers 1842a and the second touch-sensing conductive layers 1842b, such that the first touch-sensing conductive layers 1842a and the second touch-sensing conductive layers 1842b are electrically insulated from each other. In this embodiment, the first touch-sensing conductive layers 1842a are located between the filter layers 1830 and the second touch-sensing conductive layers 1842b, and the first touch-sensing conductive layers 1842a and the second touch-sensing conductive layers 1142b have different extending directions.

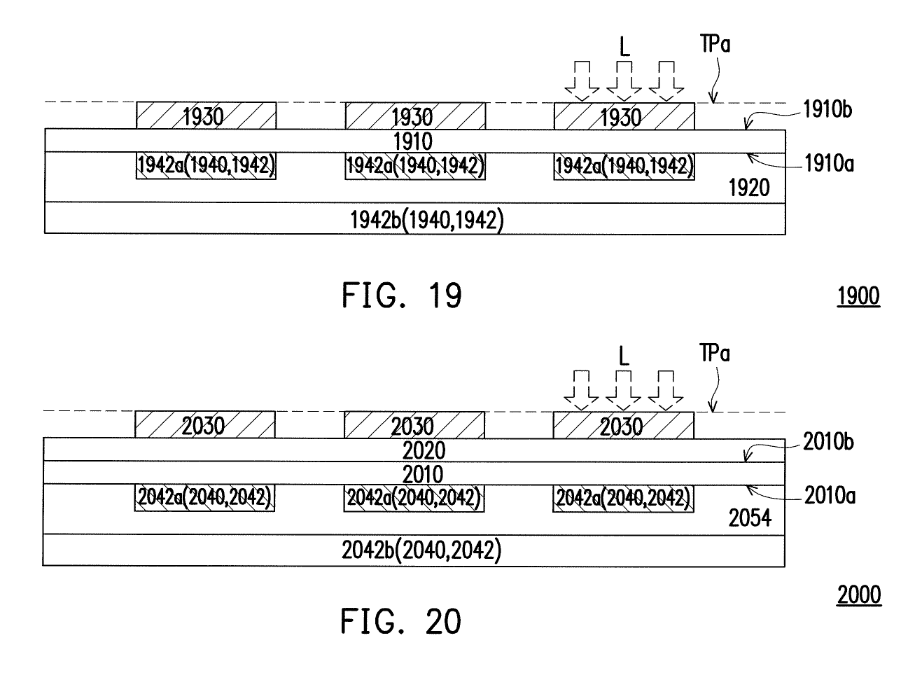

FIG. 19 is a schematic cross-sectional view illustrating a touch-sensing display panel 1900 according to a nineteenth embodiment of the disclosure. The touch-sensing display panel 1900 of the nineteenth embodiment is similar to the touch-sensing display panel 100 of FIG. 1A. Here, the touch-sensing panel TP of the touch-sensing display panel 1900 of this embodiment is described with reference to FIG. 19. It should be noted that, in FIG. 19, like or similar reference numerals represent like or similar components. Thus, components already described in FIG. 1A will not be described in the following. In this embodiment, touch-sensing device layers 1940 and a gray film 1920 are disposed on a first surface 1910a of a first substrate 1910. Filter layers 130 are stacked on a second surface 1910b of the first substrate 1910. The first substrate 1910 is located between the filter layers 1930 and the touch-sensing device layers 1940, and the touch-sensing device layers 1940 are located between the first substrate 1910 and the gray film 1920. The first substrate 1910 is located between the filter layers 1930 and the touch-sensing device layers 1940. Touch-sensing conductive layers 1942 include first touch-sensing conductive layers 1942a and second touch-sensing conductive layers 1942b electrically insulated from each other. In addition, a gray film 1920 is provided between the first touch-sensing conductive layers 1942a and the second touch-sensing conductive layers 1942b, such that the first touch-sensing conductive layers 1942a and the second touch-sensing conductive layers 1942b are electrically insulated from each other. In this embodiment, the first touch-sensing conductive layers 1942a are located between the filter layers 1930 and the second touch-sensing conductive layers 1942b, and the first touch-sensing conductive layers 1942a and the second touch-sensing conductive layers 1942b have different extending directions.

FIG. 20 is a schematic cross-sectional view illustrating a touch-sensing display panel 2000 according to a twentieth embodiment of the disclosure. The touch-sensing display panel 2000 of the twentieth embodiment is similar to the touch-sensing display panel 1600 of FIG. 16. Here, the touch-sensing panel TP of the touch-sensing display panel 2000 of this embodiment is described with reference to FIG. 20. It should be noted that, in FIG. 20, like or similar reference numerals represent like or similar components. Thus, components already described in FIG. 16 will not be described in the following. In this embodiment, touch-sensing device layers 2040 are disposed on a first surface 2010a of a first substrate 2010. Filter layers 2030 and a gray film 2020 are stacked on a second surface 2010b of the first substrate 2010. The gray film 2020 is located between the filter layers 2030 and the first substrate 2010, and the first substrate 2010 is located between the gray film 2020 and the touch-sensing device layers 2040. Touch-sensing conductive layers 2042 include first touch-sensing conductive layers 2042a and second touch-sensing conductive layers 2042b electrically insulated from each other. In addition, a second dielectric layer 2054 is provided between the first touch-sensing conductive layers 2042a and the second touch-sensing conductive layers 2042b, such that the first touch-sensing conductive layers 2042a and the second touch-sensing conductive layers 2042b are electrically insulated from each other. In this embodiment, the first touch-sensing conductive layers 2042a are located between the filter layers 2030 and the second touch-sensing conductive layers 2042b, and the first touch-sensing conductive layers 2042a and the second touch-sensing conductive layers 2042b have different extending directions.

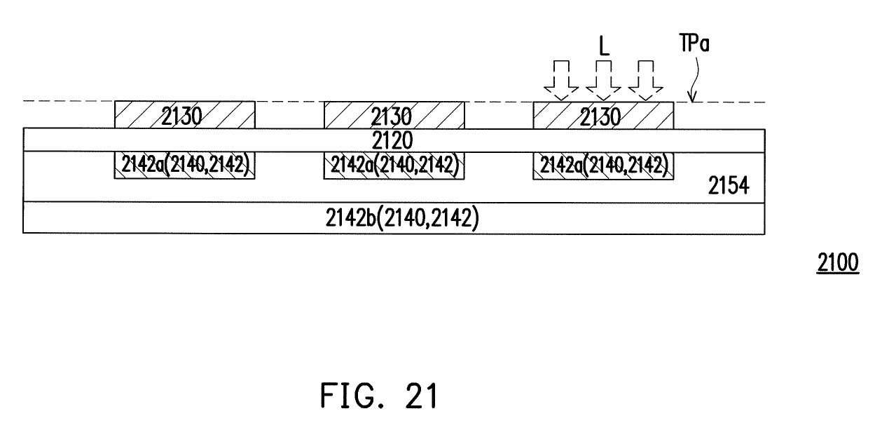

FIG. 21 is a schematic cross-sectional view illustrating a touch-sensing display panel 2100 according to a twenty-first embodiment of the disclosure. The touch-sensing display panel 2100 of the twenty-first embodiment is similar to the touch-sensing display panel 2000 of FIG. 20. Here, the touch-sensing panel TP of the touch-sensing display panel 2100 of this embodiment is described with reference to FIG. 21. It should be noted that, in FIG. 21, like or similar reference numerals represent like or similar components. Thus, components already described in FIG. 20 will not be described in the following. In this embodiment, filter layers 2130 and touch-sensing device layers 2140 are respectively disposed on opposite sides of a gray film 2120. In addition, the filter layers 2130 are located on the touch-sensing surface TPa. Touch-sensing conductive layers 2142 include first touch-sensing conductive layers 2142a and second touch-sensing conductive layers 2142b electrically insulated from each other. In addition, a second dielectric layer 2154 is provided between the first touch-sensing conductive layers 2142a and the second touch-sensing conductive layers 2142b, such that the first touch-sensing conductive layers 2142a and the second touch-sensing conductive layers 2142b are electrically insulated from each other. In this embodiment, the first touch-sensing conductive layers 2142a are located between the filter layers 2130 and the second touch-sensing conductive layers 2142b, and the first touch-sensing conductive layers 2142a and the second touch-sensing conductive layers 2142b have different extending directions.

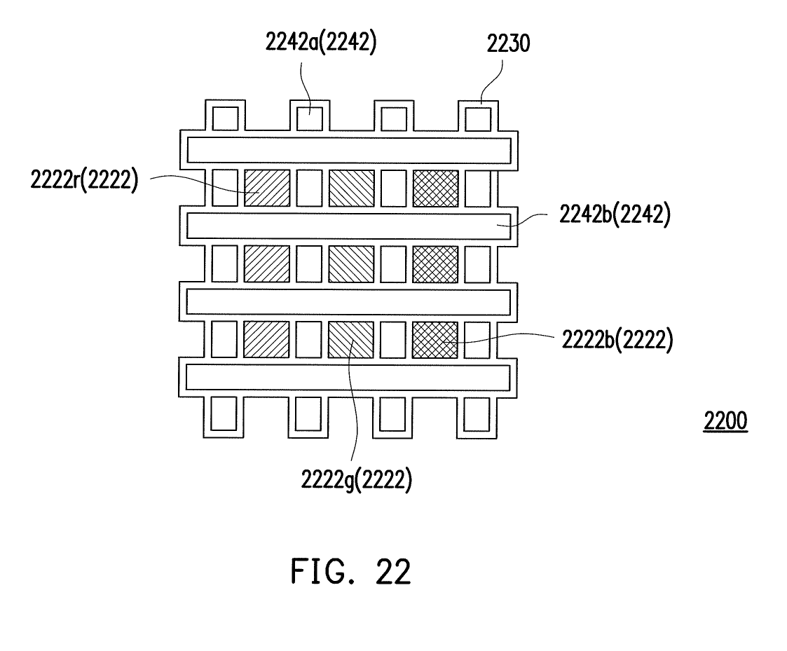

FIG. 22 is a schematic bottom view illustrating a touch-sensing display panel according to a twenty-second embodiment of the disclosure. For the purpose of clear illustration, some layers are omitted in FIG. 22. A touch-sensing display panel 2200 of the twenty-second embodiment is similar to the touch-sensing display panel 600 of FIG. 6A. Here, the touch-sensing panel TP of the touch-sensing display panel 2200 of this embodiment is described with reference to FIG. 22. It should be noted that, in FIG. 22, like or similar reference numerals represent like or similar components. Thus, components already described in FIG. 6A will not be described in the following. In this embodiment, a first touch-sensing conductive layer 2242a is located between a filter layer 2230 and a second touch-sensing conductive layer 2242b, and the first touch-sensing conductive layer 2242a and the second touch-sensing conductive layer 2242b have different extending directions. A color filter layer 2222 may be disposed between the respective filter layers 2230. In addition, the color filter layer 2222 may include a first color filter layer 222r, a second color filter layer 2222g, and a third color filter layer 222b that allow light with different colors (e.g., red light, blue light, and green light) to pass through. Taking a common arrangement as an example, each color filter layer 2222 on the touch-sensing panel TP may shield light that is not emitted by the corresponding light emitting region EM on the display panel DP, so as to reduce light leakage of the touch-sensing display panel 2200 and reinforce the display quality of the touch-sensing display panel 2200.

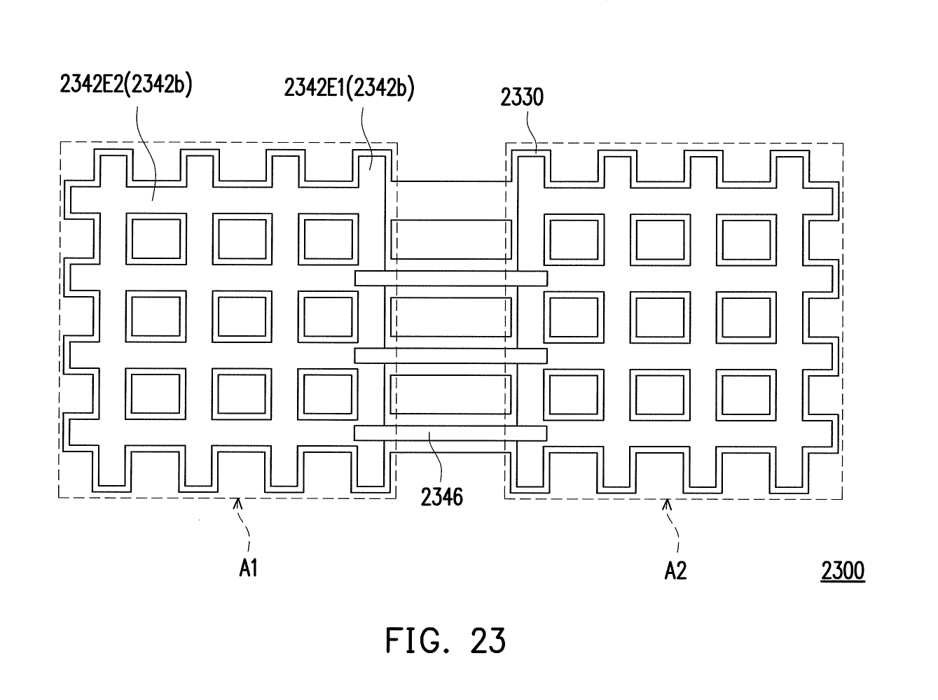

FIG. 23 is a schematic bottom view illustrating a touch-sensing display panel according to a twenty-third embodiment of the disclosure. For the purpose of clear illustration, some layers are omitted in FIG. 23. A touch-sensing display panel 2300 of the twenty-third embodiment is similar to the touch-sensing display panel 300 of FIG. 3. Here, the touch-sensing panel TP of the touch-sensing display panel 2300 of this embodiment is described with reference to FIG. 23. It should be noted that, in FIG. 23, like or similar reference numerals represent like or similar components. Thus, components already described in FIG. 3 will not be described in the following. In this embodiment, a second touch-sensing conductive layer 2342b of the touch-sensing panel TP may be a meshed electrode, for example. For example, the second touch-sensing conductive layer 2342b includes a first touch-sensing electrode 2342E1 having the same extending direction and a second touch-sensing electrode 2342E2 having the same extending direction. In addition, the extending direction of the first touch-sensing electrode 2342E1 may be substantially perpendicular to the extending direction of the second touch-sensing electrode 2342E2. In the second touch-sensing conductive layer 2342b, a portion of the first touch-sensing electrode 2342E1 and a portion of the second touch-sensing electrode 2342E2 form a first block A1, and rest of the first touch-sensing electrode 2342E1 and rest of the second touch-sensing electrode 2342E2 form a second block A2. In addition, the first block A1 and the second block A2 may be electrically connected with corresponding touch-sensing bridge 2346 through corresponding conductive vias (not shown).

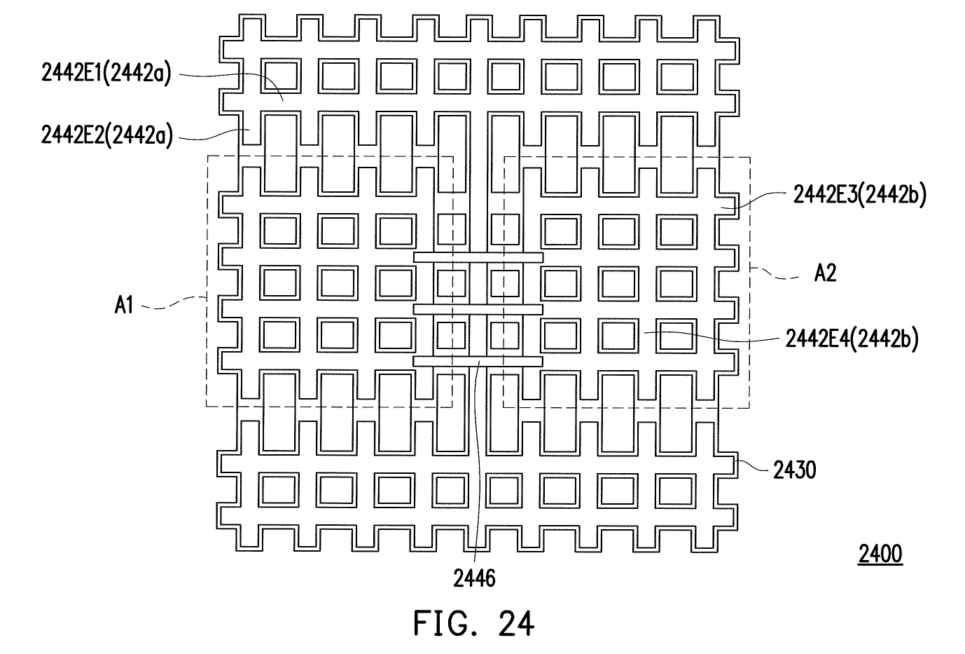

FIG. 24 is a schematic bottom view illustrating a touch-sensing display panel according to a twenty-fourth embodiment of the disclosure. For the purpose of clear illustration, some layers are omitted in FIG. 24. A touch-sensing display panel 2400 of the twenty-fourth embodiment is similar to the touch-sensing display panel 300 of FIG. 3. Here, the touch-sensing panel TP of the touch-sensing display panel 2400 of this embodiment is described with reference to FIG. 24. It should be noted that, in FIG. 24, like or similar reference numerals represent like or similar components. Thus, components already described in FIG. 3 will not be described in the following. In this embodiment, a first touch-sensing conductive layer 2442a and a second touch-sensing conductive layer 2442b of the touch-sensing panel TP are meshed electrodes, for example. For example, the first touch-sensing conductive layer 2442a has a first touch-sensing electrode 2442E1 having the same extending direction and a second touch-sensing electrode 2442E2 having the same extending direction. In addition, the extending direction of the first touch-sensing electrode 2442E1 may be substantially perpendicular to the extending direction of the second touch-sensing electrode 2442E2. The second touch-sensing conductive layer 2442b has a third touch-sensing electrode 2442E3 having the same extending direction and a fourth touch-sensing electrode 2442E4 having the same extending direction, for example. In addition, the extending direction of the third touch-sensing electrode 2442E3 may be substantially perpendicular to the extending direction of the fourth touch-sensing electrode 2442E4, the extending direction of the first touch-sensing electrode 2442E1 may be substantially parallel to the extending direction of the third touch-sensing electrode 2442E3, and the extending direction of the second touch-sensing electrode 2442E2 may be substantially parallel to the extending direction of the fourth touch-sensing electrode 2442E4. In the second touch-sensing conductive layer 2442b, a portion of the third touch-sensing electrode 2442E3 and a portion of the fourth touch-sensing electrode 2342E4 form the first block A1, and rest of the third touch-sensing electrode 2342E3 and rest of the fourth touch-sensing electrode 2342E4 form the second block A2. In addition, the first block A1 and the second block A2 may be electrically connected with corresponding touch-sensing bridges 2446 through corresponding conductive vias (not shown).

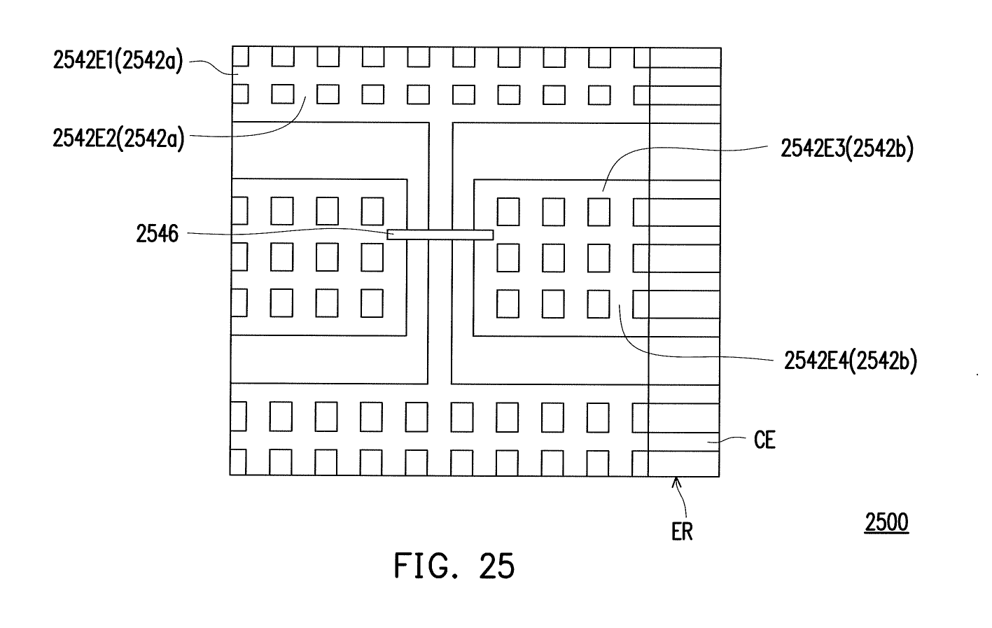

FIG. 25 is a schematic bottom view illustrating a touch-sensing display panel according to a twenty-fifth embodiment of the disclosure. For the purpose of clear illustration, some layers are omitted in FIG. 25. A touch-sensing display panel 2500 of the twenty-fifth embodiment is similar to the touch-sensing display panel 100 of FIG. 1C. Here, the touch-sensing panel TP of the touch-sensing display panel 2500 of this embodiment is described with reference to FIG. 25. It should be noted that, in FIG. 25, like or similar reference numerals represent like or similar components. Thus, components already described in FIG. 1 will not be described in the following. In this embodiment, at least one side of the touch-sensing panel TP has an electrode collecting region ER. The electrode collecting region ER has a plurality of connecting electrodes CE. Each connecting electrode CE may be electrically connected to a corresponding first touch-sensing conductive layer 2542a or a corresponding second touch-sensing conductive layer 2542b. In an embodiment, a material of the connecting electrodes CE may be the same as that of the first touch-sensing conductive layer 2542a or the second touch-sensing conductive layer 2542b. In another embodiment, a material of the connecting electrodes CE may be different from that of the first touch-sensing conductive layer 2542a or the second touch-sensing conductive layer 2542b. The material of the connecting electrodes CE may be metal, for example, and the material of the first touch-sensing conductive layer 2542a or the second touch-sensing conductive layer 2542b may be a conductive photoresist, for example. However, the disclosure does not intend to impose a limitation in this regard.

In view of the foregoing, the touch-sensing display panel according to the embodiments of the disclosure is able to reinforce the display quality.

It will be clear that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A touch-sensing display panel, comprising:
a display panel having a reflective layer; and
a touch-sensing panel, disposed on the display panel, wherein the touch-sensing panel has a touch-sensing surface and comprises at least one filter layer, a gray film, and a touch-sensing device layer, light transmitted from the touch-sensing surface toward the touch-sensing panel and the display panel is reflected by the reflective layer, an optical density ratio between the filter layer and the gray film with respect to visible light is N, and N is between 1 to 40.

2. The touch-sensing display panel as claimed in claim 1, wherein the touch-sensing panel further comprises a substrate, the filter layer, the gray film, and the touch-sensing device layer are disposed on the substrate, and the substrate has a first surface and a second surface opposite to the first surface, wherein the filter layer, the gray film, and the touch-sensing device layer are stacked on the first surface of the substrate, and the second surface of the substrate is the touch-sensing surface.

3. The touch-sensing display panel as claimed in claim 2, wherein the gray film is located on the first surface, and the filter layer is located between the touch-sensing device layer and the gray film.

4. The touch-sensing display panel as claimed in claim 2, wherein the filter layer is located on the first surface, and the gray film is located between the touch-sensing device layer and the filter layer.

5. The touch-sensing display panel as claimed in claim 1, wherein the touch-sensing device layer comprises a first touch-sensing conductive layer and a second touch-sensing conductive layer electrically insulated from each other, the first touch-sensing conductive layer is located between the second touch-sensing conductive layer and the filter layer, and the gray film is located between the first touch-sensing conductive layer and the second touch-sensing conductive layer.

6. The touch-sensing display panel as claimed in claim 5, further comprising a dielectric layer, wherein the first touch-sensing conductive layer and the filter layer are electrically insulated from each other by the dielectric layer.

7. The touch-sensing display panel as claimed in claim 5, wherein the first touch-sensing conductive layer is in contact with the filter layer.

8. The touch-sensing display panel as claimed in claim 1, wherein the touch-sensing device layer is located between the gray film and the filter layer.

9. The touch-sensing display panel as claimed in claim 8, wherein the touch-sensing device layer comprises a first touch-sensing conductive layer and a second touch-sensing conductive layer electrically insulated from each other, the first touch-sensing conductive layer is located between the second touch-sensing conductive layer and the filter layer, and the first touch-sensing conductive layer is electrically insulated from the filter layer.

10. The touch-sensing display panel as claimed in claim 8, wherein the touch-sensing device layer comprises a first touch-sensing conductive layer and a second touch-sensing conductive layer electrically insulated from each other, the first touch-sensing conductive layer is located between the second touch-sensing conductive layer and the filter layer, and the first touch-sensing conductive layer is in contact with the filter layer.

11. The touch-sensing display panel as claimed in claim 2, wherein the filter layer and the touch-sensing device layer are stacked on the first surface of the substrate, the gray film is disposed on the second surface opposite to the first surface, and the second surface of the substrate is the touch-sensing surface.

12. The touch-sensing display panel as claimed in claim 2, wherein the touch-sensing device layer is disposed on the first surface of the substrate, the filter layer and the gray film are stacked on the second surface opposite to the first surface, and the second surface of the substrate is the touch-sensing surface.

13. The touch-sensing display panel as claimed in claim 2, wherein the gray film and the touch-sensing device layer are stacked on the first surface of the substrate, the filter layer is disposed on the second surface opposite to the first surface, and the second surface of the substrate is the touch-sensing surface.

14. The touch-sensing display panel as claimed in claim 13, wherein the gray film is located between the touch-sensing device layer and the substrate.

15. The touch-sensing display panel as claimed in claim 13, wherein the touch-sensing device layer is located between the gray film and the substrate.

16. The touch-sensing display panel as claimed in claim 13, wherein the touch-sensing device layer comprises a first touch-sensing conductive layer and a second touch-sensing conductive layer electrically insulated from each other, the first touch-sensing conductive layer is located between the second touch-sensing conductive layer and the substrate, and the first touch-sensing conductive layer is electrically insulated from the second touch-sensing conductive layer by the gray film.

17. The touch-sensing display panel as claimed in claim 1, wherein the touch-sensing device layer comprises a plurality of touch-sensing conductive layers, a plurality of conductive vias, and at least one touch-sensing bridge, the conductive vias are located between the touch-sensing conductive layers and the touch-sensing bridge, and a part of the touch-sensing conductive layers are respectively electrically connected to the touch-sensing bridge through the conductive vias.

18. A touch-sensing display panel, comprising:
a display panel having a reflective layer; and
a touch-sensing panel, disposed on the display panel, wherein the touch-sensing panel has a touch-sensing surface and comprises a gray film and a touch-sensing device layer comprising a plurality of filter touch-sensing conductive layers electrically insulated from one another, light transmitted from the touch-sensing surface toward the touch-sensing panel and the display panel is reflected by the reflective layer, an optical density ratio between the filter touch-sensing conductive layers and the gray film with respect to visible light is N, and N is between 1 to 40.

19. The touch-sensing display panel as claimed in claim 18 further comprising a plurality of touch-sensing bridge, wherein a part of the filter touch-sensing conductive layers are electrically connected to each other by the touch-sensing bridge.

20. The touch-sensing display panel as claimed in claim 19, wherein the touch-sensing panel further comprises a substrate, the touch-sensing bridge are disposed on the substrate, the gray film is disposed on the substrate to cover the touch-sensing bridge, and the filter touch-sensing conductive layers are disposed on the gray film.
